(19) United States
(12) Patent Application Publication
(10) Pub. No.: US 2005/0125458 A1
(43) Pub. Date: Jun. 9, 2005

(54) Chronological data record access

(76) Inventors: James E. Sutherland, Wylie, TX (US); Leonard L. Ellis, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/729,942

(22) Filed: Dec. 9, 2003

(51) Int. Cl. G06F 17/30

(52) U.S. Cl. 707/201

(57) ABSTRACT

The Chronological Data Record Access (“CDRA”) is an internal chain that is used in a Memory Based Database Environment (MBE) to propagate records stored in volatile memory to other mirrored systems, databases, disks, etc. The CDRA associates the latest modified version of a data record and is used to process modified records without the need to queue or move the data image. The CDRA creates support in a shared-nothing environment and time-sequenced handling of information updates so that all entities may work with current information in a timely fashion.

### BACKGROUND

Memory based database environments (“MBE”) store data to volatile memory. The same needs associated with accessing data stored on disk still exist with data stored to volatile memory, e.g., permanently back up the data to disks, mirror changes to the data, etc. Thus, there exists a need to efficiently and accurately propagate records stored in volatile memory to other mirrored systems, databases, and disks, for example.

### SUMMARY

In one aspect, what is disclosed is a method for accessing data in a memory based database environment (MBE). The method includes receiving a processing request; retrieving an update from a chronological data chain; constructing a message for an MBE using the update; and sending the message to a second MBE.

In another aspect, a Chronological Data Record Access (CDRA) is disclosed. The CDRA uses a method for accessing data in an MBE that includes receiving by an MBE synchronization process (“MSP”), a processing request from a disk process emulator (“DPE”), locking a data segment of the requesting DPE, and retrieving an update from a chronological data chain.

In still another aspect, the Chronological Data Record Access is a method for accessing data in an MBE that includes receiving by an MBE file support process (“MFS”), startup information and configuration information from a manager process (“MGR”), receiving by the MFS, processing requests from a DPE,locking a data segment of the requesting DPE, and retrieving pending updates from a chronological data chain.

In yet another aspect, the Chronological Data Record Access is an apparatus for accessing data in a first MBE. The first MBE includes a DPE. The DPE maintains a chronological data chain. The apparatus also includes an MBE MSP, where the MSP uses the chronological data chain to send database modifications to a second MBE environment on behalf of the DPE.

### DESCRIPTION OF THE DRAWINGS

The detailed description will refer to the following drawings, wherein like numerals refer to like elements, and wherein:

FIG. 1 illustrates a diagram of the architecture for one embodiment of an MBE environment;

FIG. 2 illustrates a diagram of the processes and files involved in MBE configuration;

FIG. 3 illustrates a diagram of the embodiment of the MBE manager process;

FIG. 4 illustrates a diagram of one embodiment of DPE memory allocation;

FIG. 5 illustrates a diagram of how the DPE chronological data chain is maintained;

FIG. 6 illustrates a flowchart diagram depicting the steps of one embodiment of a method of using a chronological data chain for accessing data in an MBE;

FIG. 7 illustrates a diagram of the MSP processing utilizing the Chronological Data Chain;

FIG. 8 illustrates a flowchart diagram depicting the steps of one embodiment of a method of using a chronological data chain for accessing data in an MBE;

FIG. 9 illustrates a diagram of the MFS processing utilizing the Chronological Data Chain; and

FIG. 10 illustrates a flowchart diagram depicting the steps of one embodiment of a method of using a chronological data chain for accessing data in an MBE.

### DETAILED DESCRIPTION

Memory Based Database Environment (MBE) is an Enscribe compatible facility for managing application databases. Enscribe is a native file system used on NonStop systems. It is extensively used by application and system processes written for NonStop systems and thus has been chosen as the model to follow when designing MBE. MBE provides software executables and application programming interface (API) library routines that allow an application to read, insert, update, and delete memory-resident database records. The database that MBE uses may be an Enscribe database or may be memory-resident database records which can optionally be stored in a physical file on disk. MBE can support key-sequenced files and access to the data using the primary record key or alternate record key defined by the application.

MBE may operate in a shared-nothing environment, where memory content over boundaries from one CPU to another is not shared—all memory used by MBE is only shared by components of the MBE within a single CPU. No information is shared outside of the MBE or a given CPU except for information that can be accessed or modified through the standard MBE API. MBE provides the ability to partition the database by primary key across multiple CPUs. Unlike Enscribe, which allows a maximum of 16 partitions across disk volumes, MBE supports a maximum of 1000 partitions limited by the number of CPUs and the amount of memory per CPU on the system where the MBE is operating. MBE may run in a fault tolerant environment that allows all critical data to be backed up automatically in a secondary CPU. MBE also has the ability to manage database updates for one or more remote systems and to synchronize updates with those remote systems.

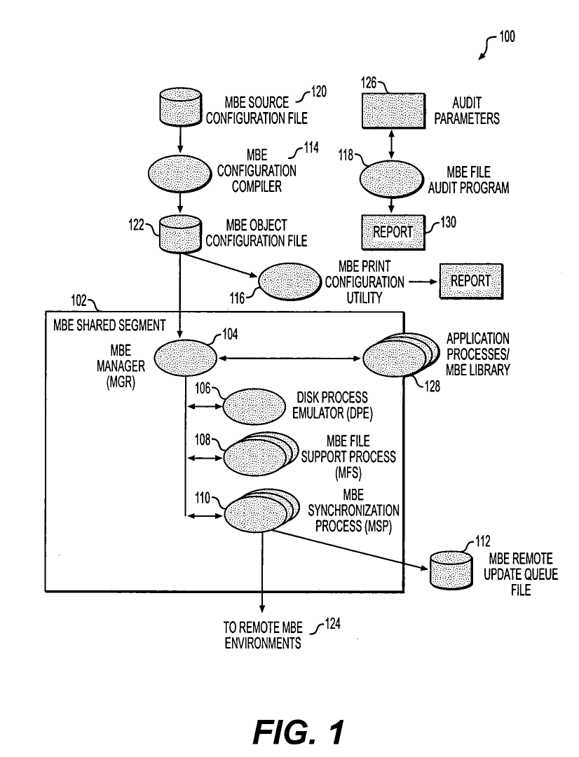

With reference now to FIG. 1 of the drawings, there is illustrated therein one embodiment of a memory based database environment (“MBE”), generally designated by the reference numeral 100. The MBE environment 100 is comprised of support and utility programs (not shown). The MBE Configuration Compiler 114 compiles the MBE configuration settings. The MBE Configuration Compiler program 114 is used to process the file containing the source configuration settings for the MBE environment and convert the source information into the internal format used by the MBE run-time environment. The input file is called the MBE Source Configuration file 120 and it is used to define the global parameters, the remote systems, and file attribute settings for all files used for a particular MBE environment 100. The output of the compiler is called the MBE Object Configuration file 122 which defines the MBE environment 100 and is used as input to the MBE Manager process (MGR) 104. The compiler generates tables and records in the MBE Object Configuration file 122 so that the MGR 104 does not need to do that at startup. The MBE Configuration Print Utility 116 prints the MBE configuration settings. The MBE Audit Program 118 compares records in two files or synchronizes record contents in two files, or both.

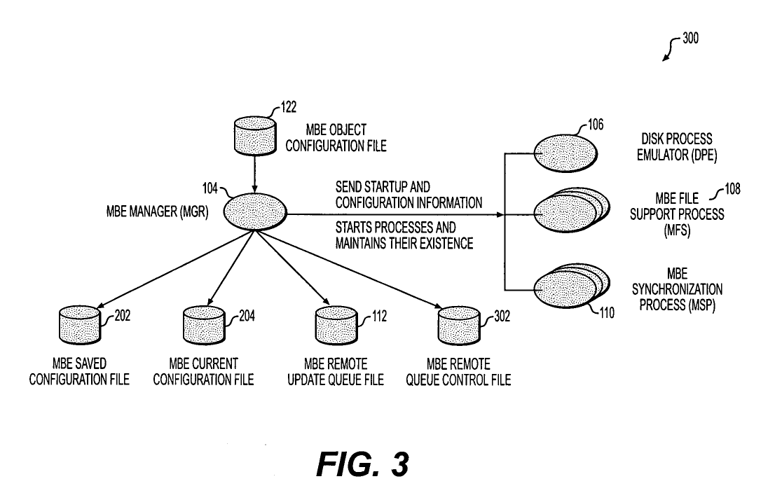

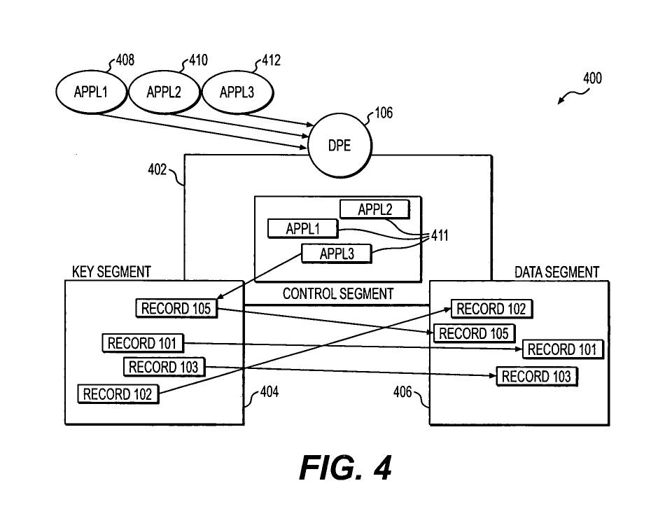

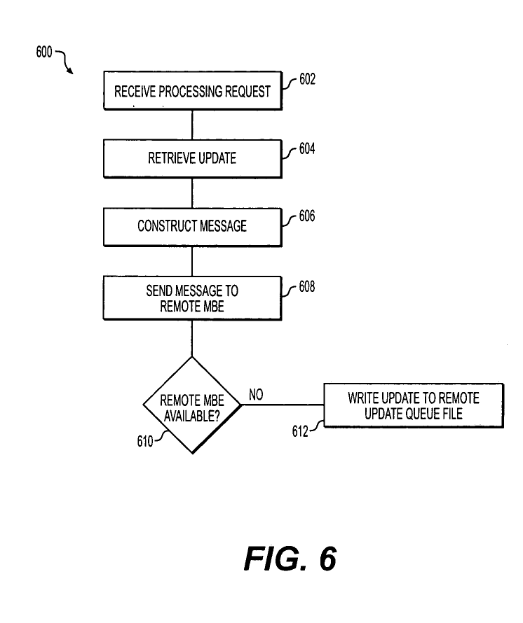

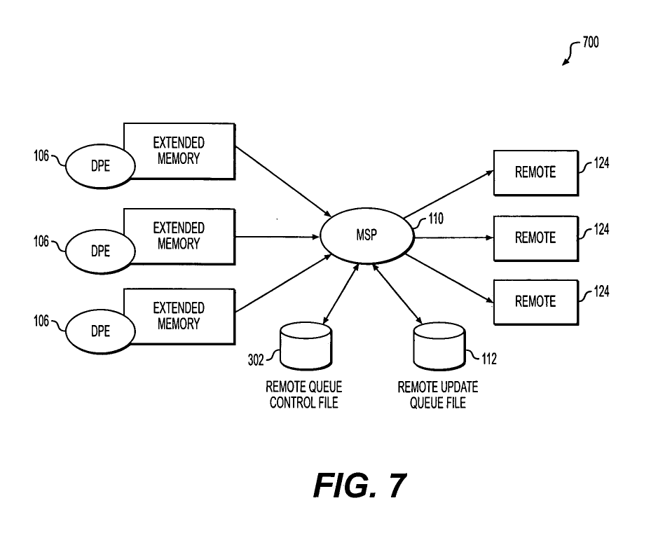

The MBE Shared Segment 102 is composed of the MBE Manager (MGR) 104 (FIG. 3), the Disk Process Emulator (DPE) 106 (FIG. 4), the MBE File Support process 108 (MFS) (FIG. 7), and the MBE synchronization process 110 (MSP) (FIG. 6). As detailed herein below, the MBE environment can be configured to synchronize database changes with a remote MBE environment 124. The remote MBE environments 124 may be, but are not limited to other mirrored systems, databases, disks, etc. A mirrored system is one that acts as an active-backup system to the local MBE system. Both systems would be configured with a “live” duplicate copy of the same MBE file(s). The synchronization function of MBE is used to keep a “mirror” image of the data on both systems. In an embodiment, two files may be associated with this capability: the Remote Update Queue file 112, and the Remote Queue Control file (FIG. 3). Remote Update Queue file 112 contains any database updates that were undeliverable to a remote MBE environment 124. Certain embodiments may have more than one Remote Update Queue file 112. The MBE MSP 110 adds an entry to the Remote Update Queue file 112 for each record change that is not successfully processed by the remote MBE environment 124. A minimum of one Remote Update Queue file 112 is created for each copy of the MBE MSP 110. If a remote MBE environment is down for an extended period of time and its Remote Update Queue file 112 becomes full, a new queue file will be created and linked to the remote. These sequentially numbered files may be purged each time the MBE Manager 104 process is started. The Remote Queue Control file contains one record for each Remote Update Queue file 112. Records are used to keep track of the queue files and to store each file name and its current state. During remote recovery, the MBE MSP 110 reads through the record entries to determine which Remote Update Queue file 112 need to be processed to recover a particular remote system. The Remote Queue Control file 302 (FIG. 3) may be created anew each time the MBE Manager process 104 is started. The audit parameters 126 pertain to a external program that can be executed on demand. The function of this audit program 118 is defined by parameters set when the user initiates the program. The audit can perform a comparison of the contents of two files 130, and optionally synchronize the content of the two files being compared. The application is any process that uses the application library 128 to access key sequence data stored within an MBE file. The application library 128 contains the programming functions that allow the application the access to the MBE data.

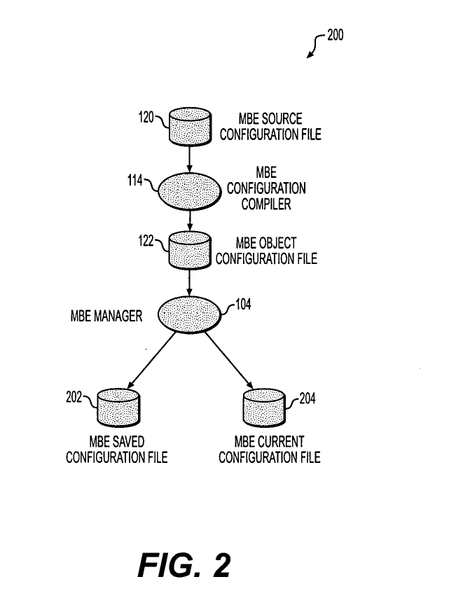

With reference now to FIG. 2 of the drawings, there is illustrated therein one embodiment of MBE configuration file environment, generally designated by the reference numeral 200. All configuration information for an MBE environment is defined in a single MBE Source Configuration file 120. User configurable information may include process parameters, file attributes, and definitions for remote systems. The MBE Source Configuration file 120 provides input to the MBE Configuration Compiler 114, which creates a compiled file called the MBE Object Configuration file 122 that is used by MBE to define a specific MBE environment 100. When the MBE environment 100 is started, the MBE Manager 104 process creates a saved copy of the last MBE configuration in the MBE Saved Configuration file 202 and it uses the MBE Object Configuration file 122 to create the MBE Current Configuration file 204. The MBE Manager 104 process uses information in the MBE Object Configuration file 122 to spawn other processes and set up files in the MBE environment 100.

The following summarizes the files involved in the configuration process: The MBE Source Configuration file 120 contains all of the user configurable settings for an MBE environment. This file is used as input for the MBE Configuration Compiler 114 to create the MBE Object Configuration file 122. The MBE Object Configuration file 122 contains the output from the MBE Configuration Compiler 114 after processing the MBE Source Configuration file 120. This MBE Object Configuration file 122 is used by the MBE Manager 104 process to define the MBE environment. The MBE Current Configuration file 204 is the run-time copy of the MBE Object Configuration file 122 created by the MBE Manager 104 process at startup. The MBE Manager 104 process also stores process status information for all processes in the MBE environment in the MBE Current Configuration file 204. If the primary MBE Manager 104 process fails, the backup process retrieves the current status information from the MBE Current Configuration file 204. The MBE Saved Configuration file 202 contains the previous configuration settings for the environment. The MBE Saved Configuration file 202 is a saved copy of the previous MBE Current Configuration file 204 and is created by the MBE Manager 104 process at startup.

With reference now to FIG. 3 of the drawings, there is illustrated therein one embodiment of the MBE manager process, generally designated by the reference numeral 300. The following MBE processes, depicted in FIG. 1, comprise the MBE run-time environment: MBE Manager process (MGR) 104, Disk Process Emulator (DPE) 106, MBE Synchronization Process (MSP) 110, and MBE File Support process (MFS) 108. FIG. 3 describes what the above processes do and how the processes interact in the MBE environment. The MBE MGR 104 may be defined by a unique process name (such as $MBE1). This unique process name serves as the volume name for a set of files defined within the MBE environment. The MGR 104 name is equivalent to the volume name of a DP2 disk volume that contains subordinate subvolumes and files.

The MGR 104, the central control process for an MBE environment, provides the following functionality at startup: 1) The MGR 104 copies the most recent MBE Current Configuration file 204 to the MBE Saved Configuration file 202. It then uses the current MBE Object Configuration file 122 to create a new MBE Current Configuration file 204. After startup, MGR 104 uses the MBE Current Configuration file 204 to store process status information for the MBE environment; 2) The MGR 104 process resolves all unresolved file and process names defined in the MBE Object Configuration file 122; 3) The MGR 104 process processes and stores all configuration information retrieved from the MBE Object Configuration file 122 for its own use and use by all subordinate MBE processes; 4) The MGR 104 process initializes the Remote Queue Control file 302 using settings in the MBE Object Configuration file 122; 5) The MGR 104 process purges and initializes Remote Update Queue file 112 using settings in the MBE Object Configuration file 122; and 6) The MGR 104 starts and maintains all MBE processes for the MBE environment based on settings in the MBE Object Configuration file 122: Disk Process Emulator 106, MBE Synchronization process 110, and MBE File Support process 108. MGR 104 automatically restarts and reconfigures any process within the MBE environment that stops. The MGR 104 process functions as a monitor for all other processes within the MBE environment. The MGR 104 will initially start all processes required and in the event any of the processes fail or is stopped; the MGR 104 will automatically restart it.

During program operation, the MGR 104 processes file open requests and provides the MBE API routines with the information needed to open the appropriate Disk Process Emulator (DPE) processes 106 based on file name and partition key definitions in the MBE Object Configuration file 122.

When an application opens a file using the MBE API, the MBE FILE OPEN or MBE_OPEN library routine performs these steps: 1) Determines if there is an active MGR 104 with a name that matches the volume name of the file to be opened; 2) If the MGR 104 name exists, sends an open message to the MGR 104. If the file is defined in the MBE environment of the MGR 104, the open information is returned to the calling process and the selected DPE 106 are then opened by the application. If the file is not defined, an error 11 is returned to the calling process; and 3) If the MGR 104 name does not exist, the routine calls the standard Enscribe FILE_OPEN_ or OPEN library routines and attempts to open the file as a standard Enscribe file. All subsequent I/O from within the application is performed using the standard Enscribe based MBE routines to read, update, insert, and delete database records.

With reference now to FIG. 4 of the drawings, there is illustrated therein one embodiment of DPE memory allocation, generally designated by the reference numeral 400. The Disk Process Emulator (DPE) 106 stores MBE database records in the memory-resident MBE table and manages access to the records. One copy of the DPE 106 is started for each file or file partition defined in the MBE Object Configuration File 122 (FIG. 1). The DPE 106 can be configured to run as a NonStop process pair and check point every database modification to a backup copy of the process. A NonStop process pair is unique to the operating system of the NonStop environment (not shown). The NonStop process pair allows for a process (the primary) to start a backup copy of itself in a different CPU on the same system. The “primary” process will then keep its “backup” process up to date with all data and state changes via a mechanism called check-pointing. In the case of the DPE 106, all changes in the state of applications 408, 410, 412 (opens and closes), all changes in the state of records 101, 102, 103, 105 (locks and unlocks), and all modified records are check-pointed to the backup DPE 106. In the event the primary process or CPU were to fail, a backup DPE 106 could resume processing where the primary left off. On startup, the DPE 106: 1) receives startup information from the MGR 104 (FIG. 1); 2) receives MBE configuration information from the MGR 104; and 3) if configured to do so, loads the database from an existing Enscribe file into the MBE tables. If the file is partitioned, each DPE 106 loads only the data associated with the defined key range for its partition. The key range is defined by the configuration within the MBE Configuration Source file 120 (FIG. 1).

The process control information and database records maintained within each DPE are stored in a set of flat shared extended data segments. Each of these segments is used as follows: Control Segment 402 stores application information 411, including application control information, file lock chain, and wait queue for file lock chain, control settings, statistics, counters, and control settings. The application information 411 may point to one or more records 101, 102, 103, 105. Key Segment 404 stores the pool containing the keys and uses index blocks that point to the data records in Data Segment 406. The size of the Key Segment 404 is user defined. The Key Segment 404 is similar to a look-up table in the way the data is stored.

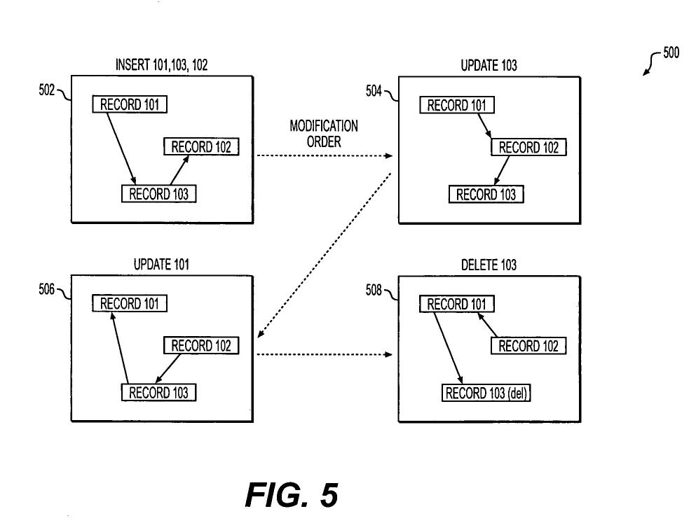

A user may generate a request to access data by key. Examples of key data may be a mobile telephone number, or some other generic data. The Data Segment 406 stores the pool containing the database record images. The size of the Data Segment 406 may be user defined. Each record may be stored with an internal MBE record header. Data records are stored in the pool using standard buffer creation and deletion routines. When a record is inserted or modified, it is placed on the end of the chronological data chain that is maintained by the DPE 106. This chain allows for the processing of modified records without requiring a separate queue of record images (FIG. 5). There is an internal mechanism containing a beginning record pointer in the data segment 406 that determines which records need to be propagated across to the other systems and also written to disk. Only the most recent record image is required for updates to physical disk or remote systems. This internal mechanism does not access the data via the record key, but uses the chronological data chain to determine the most current record image to process. Thus, there are two ways to look at the data: chronologically as the data is modified, and from the application or user's perspective.

With reference now to FIG. 5 of the drawings, there is illustrated therein one embodiment of DPE chronological data chain, generally designated by the reference numeral 500. The chronological data chain 500 historically keeps track of changes in order to propagate those changes to other systems, or to create a mere copy of the dataflow. The chronological data chain is an internal mechanism that keeps track of the latest view of the data in memory where it already is located and accessed on a local system. As the remote updates are sent, the updates only go through that change in a chronological manner, putting the data back together on the other systems, or on to disk, in the same order that the data was updated locally on the originating system. The chronological data chain is a way of keeping track of modified records or modified data in a given MBE that need to be propagated either to one or multiple remote MBEs, or written to disk for permanent storage.

FIG. 5 illustrates how the DPE chronological data chain 500 is maintained when records are inserted, updated, and deleted. During program operation, the DPE 106 functions as a server and waits on database requests from a user application e.g., 408, 410, 412. As application open messages are received, the application name is stored in the Application Control Table (not shown) for identification and used to free up locks and other resources in the event the application stops during processing.

When a read, update, or delete is requested, the DPE 106 looks up the record key in the key segment. If the record exists, the key segment entry contains a pointer to the location of the data record within the data segment. If the record does not exist, an error 11 is returned. When an insert is requested, the DPE 106 looks up the record key in the key segment. If the record does not exist, a new data record is created within the data segment and new key segment entry is created with a pointer to the newly created record image. If the record does exist, an error 10 is returned. Any error operation returns either a standard Enscribe error code or in some cases a specific MBE error code.

If the DPE 106 has a backup process and the application requests a record update, the modified record image is sent to the backup process before the reply is made to the calling application. On all record accesses, the DPE 106 first checks to see if the record is locked. If the record is locked by the calling process, the operation is allowed. On the other hand, if the record is locked by a different process, the request is placed on the Wait for Lock Queue and the calling application is suspended awaiting completion at which time the lock is released.

When a record lock request is received, the DPE 106 checks to see if the record is already locked. If the record is not locked or if the record is locked by the calling process, the operation is allowed. On the other hand, if the record is locked by a different process, the request is placed on the Wait for Lock Queue and the calling application is suspended awaiting completion at which time the lock is released. All locks are placed on an internal Lock Queue with pointers from the Application Open entry, this allows for the removal of all record locks held by a given process that fails to unlock the record(s) before it stops executing. The DPE 106 also periodically sends work requests to the MBE File Support Process 108 or the MBE Synchronization Process 110, or both processes.

The above principles are illustrated in FIG. 5 in simplistic manner. At step 502 records 101, 103 and 102 are inserted and record 101 is at the beginning of the chain and record 102 is at the end. At step 504 record 103 is updated and record 103 moves to the end of the chain and record 101 remains at the beginning of the chain. At step 506 record 101 is updated and record 101 moves to the end of the chain, leaving record 102 at the beginning of the chain. At step 508 record 103 is deleted and record 103 moves to the end of the chain and record 102 is at the beginning of the chain. The CDRA causes the record with latest change to be at the end of the chain. Thus, records will logically be processed in the order in which they were modified.

With reference now to FIG. 6 of the drawings, there is illustrated therein a flowchart diagram depicting the steps of one embodiment of a method of using a chronological data chain for accessing data in an MBE, generally designated by the reference numeral 600. The method begins with the receipt of a processing request in step 602. The processing request is initiated by the DPE 106 and is forwarded to the MSP 110. Next, an update is retrieved from the chronological data chain in step 604. The chronological data chain is an internal chain that includes a latest modified version of a data record of the first MBE. The first MBE may be a shared-nothing environment. The chronological data chain is used to process modified records without a need to queue or move data in the first MBE. The update may represent changes to records or data and may be retrieved by an MBE. The update is then used to construct a message to send to a remote, or second, MBE in step 606. The message may be of various formats known to those in the art and communicates the updates to the second MBE. The remote MBE may be a mirrored system, a database, or a disk. The message is then sent to a remote MBE in step 608. Lastly, if the remote MBE is not available in step 610, the retrieved update is written to a remote update queue file in step 612, which may be located locally, or physically outside the MBE. If the second MBE is available, the message is sent in regular fashion.

With reference now to FIG. 7 of the drawings, there is illustrated therein one embodiment of the MBE synchronization process, generally designated by the reference numeral 700. The MBE Synchronization Process (MSP) 110 is responsible for sending database modifications to remote MBE environments 124 on behalf of one or more DPEs 106. The MSP 110 is notified of pending database changes by a DPE 106, attaches to the DPE Data Segment, and processes the pending modifications.

At startup, the MSP 110: 1) receives startup information and MBE configuration information from the MGR 104, and 2) builds remote route tables based on the content read from the MBE Object Configuration file 122 and uses the C Heap for table storage. When the MSP 110 receives a processing request from a DPE 106, it locks the data segment of the requesting DPE. MSP 110 then retrieves the pending updates from the chronological data chain and constructs messages for the configured remote MBE environments 124. It unlocks the data segment and sends all pending messages to the appropriate remote MBE environment 124 if it is available, then waits for completion messages from the remotes. If the remote MBE environment 124 is not available, the MSP 110 writes updates to the appropriate Remote Update Queue file 112. If the MSP 110 fails, on restart it uses the Remote Queue Control file 302 to determine which Remote Update Queue file 112 it needs to process and to determine the state of those files. Extended memory is any memory allocated outside to the process data space. Or in other words, extended memory is addressable memory that is not global, local, or within the heap. Each of the memory segments allocated by the DPE 106 is considered extended memory.

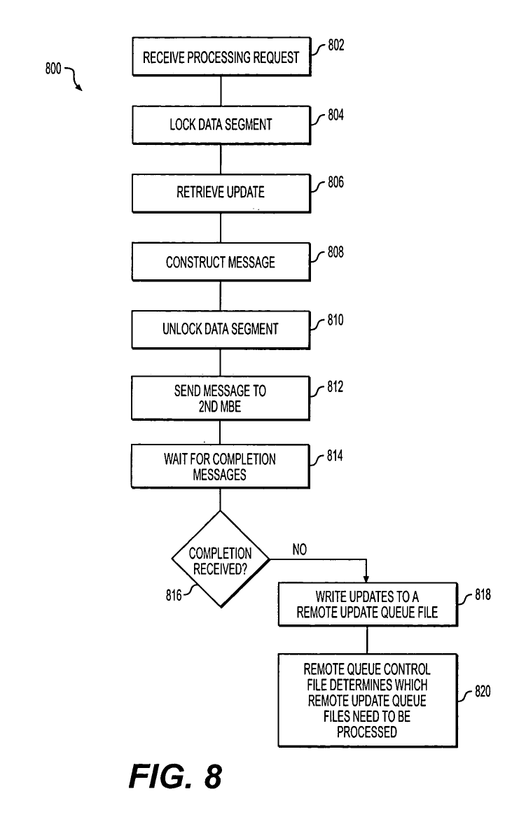

With reference now to FIG. 8 of the drawings, there is illustrated therein a flowchart diagram depicting the steps of another embodiment of the method of using a chronological data chain for accessing data in an MBE, generally designated by the reference numeral 800. The MBE may be a shared-nothing environment. The method begins by receiving a processing request from a DPE 106 in step 802. Preferably, the processing request is received by an MBE MSP 110, but may be received by other software. Next, the data segment of the requesting DPE 106 is locked in step 804. Then, the MSP 110 retrieves an update from the chronological data chain in step 806. The chronological data chain is an internal chain that includes a latest modified version of a data record of the first MBE. The chronological data chain is used to process modified records without a need to queue or move data in the first MBE. The update is then used to construct a message for a second MBE in step 808. The second MBE may be a mirrored system, a database, a disk, etc. Then the data segment is unlocked in step 810. The message is then sent to a second MBE, if the second MBE is available in step 812. The method then waits for completion messages from the second MBE in step 814. If the second MBE is not available in step 816, e.g., the completion is not received, the updates are written to a remote update queue file in step 818. Lastly, if the MSP 110 fails, a remote queue control file is used on restart to determine which Remote Update Queue file needs to be processed, and to determine the state of said Remote Update Queue file in step 820.

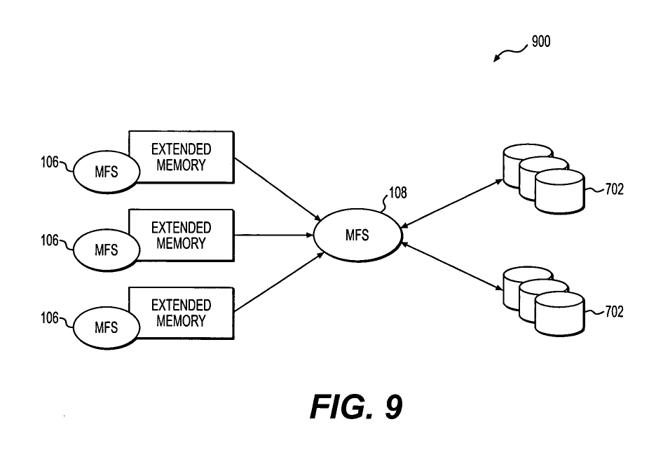

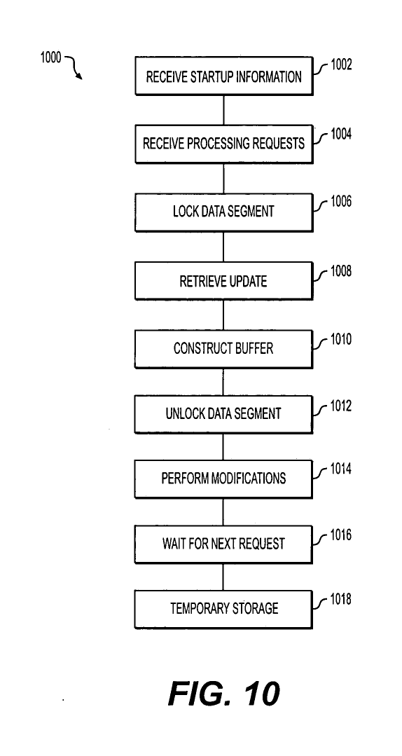

With reference now to FIG. 9 of the drawings, there is illustrated therein one embodiment of the MBE file support process (“MFS”) 108, generally designated by the reference numeral 900. MBE MFS 108 is responsible for applying database modifications to a physical data file on behalf of one or more DPEs 106. When the MFS 108 is notified of pending database changes by a DPE 106, it attaches to the DPE 106 data segment and processes the pending database changes. At startup, the MFS 108 receives startup information and configuration information from the MGR 104 and awaits processing requests from a DPE 106. When the MFS 108 receives such a request from a DPE 106, it locks the data segment of the requesting DPE 106 and retrieves the pending updates from the Chronological Data Chain. MFS 108 then constructs an internal update buffer of pending changes, unlocks the data segment, and then performs the database modifications to the specified file 702. MFS 108 then awaits the next request from a DPE 106 and uses the DPE control segment for temporary storage of bundles of updates With reference now to FIG. 10 of the drawings, there is illustrated therein a flowchart diagram depicting the steps of another embodiment of the method of using a chronological data chain for accessing data in an MBE, generally designated by the reference numeral 1000. The method begins by receiving by an MBE MFS, startup information and configuration information from a MGR 104 in step 1002. Next the MFS 108 receives processing requests from a DPE 106 in step 1004. The data segment of the requesting DPE 106 is then locked in step 1006 and an update is retrieved from a chronological data chain in step 1008. An internal update buffer of pending changes is then constructed in step 1010 and the data segment is unlocked in step 1012. Next the database modifications are performed to a specified file in step 1014. The method then waits for the next request from a DPE 106 in step 1016 and uses the DPE 106 control segment for temporary storage of bundles of updates in step 1018.

The CDRA may be applied to varying applications of MBE databases. For example, the CDRA may be used in MBE databases associated with telephony, financial, travel and scheduling applications. The specific type of MBE database application is not important to the scope of the CDRA and should not be construed to limit the application of the CDRA in any way. Appropriate computer hardware can be used to run the CDRA. For example, the software may run on a PC, or other computer, and can be stored in a memory device, or other computer readable medium.

The inventions set forth above are subject to many modifications and changes without departing from the spirit, scope or essential characteristics thereof. Thus the embodiments explained above should be considered in all respect as being illustrative rather than restrictive of the scope of the inventions as defined in the appended claims.

1. A method for accessing data in a first memory based database environment (MBE), said method comprising the steps of:
receiving a processing request;
retrieving an update from a data chain associated with the first MBE;
constructing a message for an MBE using the retrieved update; and
sending the message to a second MBE.

2. The method according to claim 1, wherein said data chain is a chronological data chain.

3. The method according to claim 1, further comprising the step of:
writing the retrieved update to an update queue file, if the second MBE is not available.

4. The method according to claim 1, wherein the data chain is an internal chain that includes a latest modified version of a data record of the first MBE.

5. The method according to claim 1, wherein the data chain is used to process modified records without a need to queue or move said modified records in the first MBE.

6. The method according to claim 1, wherein the second MBE is selected from a group consisting of: a mirrored system, a database, or a disk.

7. The method according to claim 1, wherein said first MBE is a shared-nothing environment.

8. A method for accessing data in a first memory based database environment (MBE), said method comprising the steps of:
receiving a processing request from a disk process emulator (“DPE”) process;
locking a data segment of a DPE; and
retrieving an update from a data chain.

9. The method according to claim 8, wherein said data chain is a chronological data chain.

10. The method according to claim 8, wherein the steps are accomplished by an MBE synchronization process (“MSP”).

11. The method according to claim 8, further comprising the step of:
constructing a message for a second MBE.

12. The method according to claim 11, wherein said second MBE environment is selected from a group consisting of: a mirrored system, a database, or a disk.

13. The method according to claim 11, further comprising the step of:
unlocking the data segment.

14. The method according to claim 13, further comprising the step of:
sending the message to the second MBE, if it is available.

15. The method according to claim 14, further comprising the step of:
waiting for a completion message from the second MBE.

16. The method according to claim 13, further comprising the step of:
writing updates to an update queue file, if the second MBE is not available.

17. The method according to claim 16, wherein there are more than one update queue files, further comprising the step of:
using a queue control file, on restart if the MSP fails, to determine which update queue file needs to be processed, and to determine a state of said update queue files.

18. The method according to claim 8, wherein the data chain is an internal chain that includes a latest modified version of a data record of the first MBE.

19. The method according to claim 8, wherein the data chain is used to process modified records without a need to queue or move said modified records in the first MBE.

20. The method according to claim 8, wherein the first MBE is a shared-nothing environment.

21. A method for accessing data in a memory based database environment (MBE), said method comprising the steps of:
receiving by an MBE file support process (“MFS”), startup information and configuration information from a manager process (“MGR”);
receiving by said MFS, processing requests from a disk process emulator (“DPE”) process;
locking a data segment in response to the processing requests; and
retrieving an update from a data chain.

22. The method according to claim 21, wherein said data chain is a chronological data chain.

23. The method according to claim 21, further comprising the steps of:
constructing an internal update buffer of pending changes; and
unlocking the data segment.

24. The method according to claim 23, further comprising the steps of:
performing a database modification to a specified file;
awaiting the next request from a DPE; and
using the DPE control segment for temporary storage of bundles of updates.

25. An apparatus for accessing data in a first memory based database environment (“MBE”), said apparatus comprising:
a disk process emulator, said disk process emulator maintaining a chronological data chain; and
an MBE synchronization process, wherein said MBE synchronization process uses said chronological data chain to send database modifications to a second MBE environment on behalf of said disk process emulator.

26. The apparatus of claim 25 wherein said chronological data chain is an internal chain that includes the latest modified version of a data record.

27. A computer-readable medium comprising instructions to cause a computer in a memory based database environment (MBE) to:
receive processing requests from a disk process emulator (“DPE”) process;
lock a data segment of the requesting DPE; and
retrieve a pending update from a data chain.

28. The computer-readable medium according to claim 27, wherein said data chain is a chronological data chain.

29. The computer-readable medium according to claim 27, wherein the data chain is an internal chain that associates the latest modified version of a data record.

30. The computer-readable medium according to claim 27, wherein the data chain is used to process modified records without the need to queue or move said modified records.
